(19) United States
(12) Patent Application Publication
(10) Pub. No.: US 2002/0123931 A1
(43) Pub. Date: Sep. 5, 2002

(54) Web access for prepaid/postpaid account information and services

(75) Inventors: Anthony Splaver, Camas, WA (US); Richard Wymore, Clackamas, OR (US)

Correspondence Address: MARGER JOHNSON & McCOLLOM, P.C., 1030 S.W. Morrison Street, Portland, OR, 97205, US

(73) Assignee: Communications Product Development, Inc., Vancouver, WA

(21) Appl. No.: 10/090,847

(22) Filed: Mar. 4, 2002

Related U.S. Application Data
(60) Provisional application No. 60/273,148, filed on Mar. 2, 2001.

(51) Int. Cl. G06F 17/60; H04M 15/00

(52) U.S. Cl. 705/14; 379/114.2

(57) ABSTRACT

The Web Access invention allows account holders to view their account information over the Internet, and gives account holders access to telephony features via the Internet. The features of the Web Access invention include login, security, account history, PIN maintenance, merging accounts, callback, recharging accounts with a credit card, purchasing accounts with a credit card, retrieving fax mail, retrieving voicemail, viewing recharge history, and viewing rate information.

### CROSS-REFERENCES TO RELATED APPLICATIONS

This application claims the benefit from U.S. Provisional Patent Application No. 60/273,148 filed Mar. 2, 2001 whose contents are incorporated herein for all purposes.

### BACKGROUND OF THE INVENTION

1. Field of the Invention.

This invention relates generally to on-line account tracking and more particularly to a system for tracking and accessing information over a global communications network such as the Internet, via active server pages, that reflect use of a telephone account where telephone usage through a call control processor is automatically routed to an SQL database accessible by a user using Internet-enabled computers.

2. Description of the Prior Art.

There are various methods for communicating with someone from a remote location, including conducting a live telephone conversation, sending a direct dial facsimile transmission through the telephone lines, sending an e-mail message through a global communications network such as the Internet, leaving a voice mail message on the person's personal answering machine or on a central server. Systems exist that allow a user to access voice mail messages only via a telephone where the user is prompted to navigate through the various messages using audio cues and instructions.

Accordingly, the need remains for an integrated communications account where a user can retrieve, track and prepay for access to an account that stores fax and voice messages accessible by a web user from a computer.

### SUMMARY OF THE INVENTION

The Web Access invention allows account holders to view their account information over the Internet, and gives account holders access to telephony features via the Internet. The features of the Web Access invention include login, security, account history, PIN maintenance, merging accounts, callback, recharging accounts with a credit card, purchasing accounts with a credit card, retrieving fax mail, retrieving voicemail, viewing recharge history, and viewing rate information.

The scope of this invention under its current form would best apply to prepaid/postpaid telephone calling card and/or metered Internet access activity. However, this invention in its plurality could embody a method of accessing account information for various types of other services where an account database is accessible over the Internet.

The method for the prepaid account scenario includes first establishing a prepaid account, including a validation number, and then receiving an electronic communication to said prepaid account. The electronic communication is stored in a central repository. A user can then log in to the central repository from a remote computer using the validation number. The electronic communication is served to the remote computer and the prepaid account is decremented.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is the block diagram of the Web Access components.

FIG. 2 is the flow diagram for the Web Access invention.

FIGS. 3A and 3B are flow diagrams for the voice mail feature for telephone users and web users, respectively.

FIGS. 4A and 4B are flow diagrams for the fax mail feature for telephone users and web users, respectively.

FIG. 5 is the flow diagram for reviewing the call history and recharge history information.

FIG. 6 is the flow diagram for the rate information, callback, merge and PIN features.

FIG. 7 is the flow diagram for the recharge and purchase features.

FIG. 8 illustrates the account history web page.

FIG. 9 is the voice mail web page.

### DETAILED DESCRIPTION

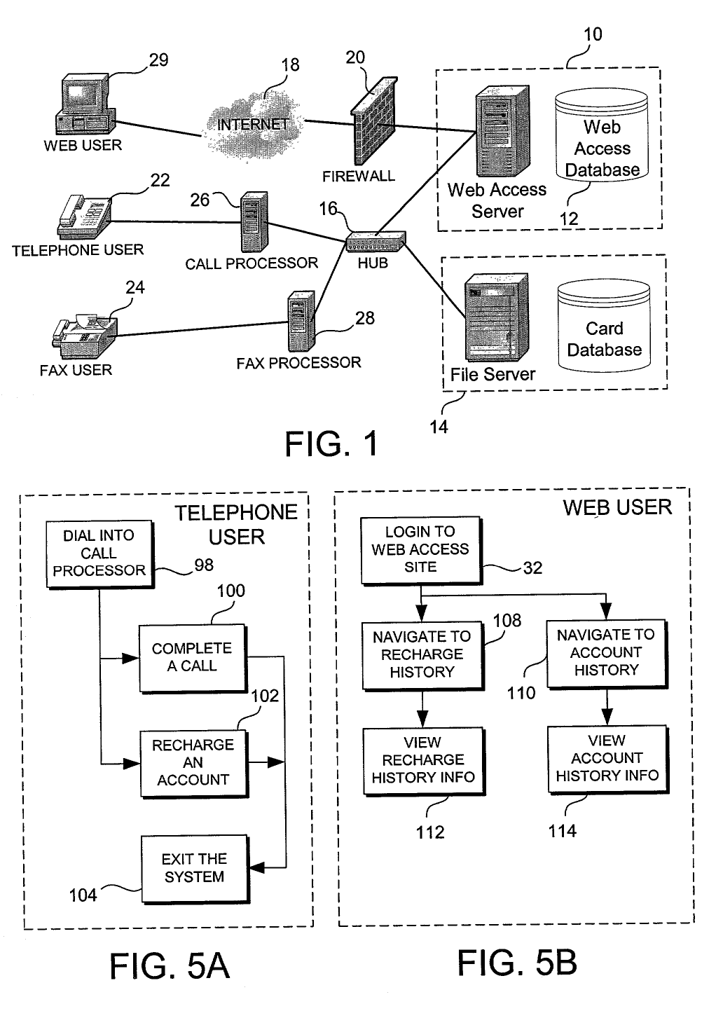

FIG. 1 shows the required components for the Web Access invention. The software required to make the Web Access invention operate is located on a web access server 10. The web access server is a Pentium III computer with 256 MB of memory and 20 GB of disk storage. The web access server contains a database 12 that warehouses the call history and recharge history information. This database 12 is updated by software on the web access server that continually retrieves the data from a file server 14, coupled via hub 16 to web access server 10. The web pages validate account information from the account database with software on file server 14. The web access server 10 is used to host the web pages on the Internet 18 (described below with reference to the flow diagrams illustrating the operation of the web access method described). A firewall 20 provides security protection between the web access server 10 and the Internet 18. Telephone 22 and fax users 24 interact with the call processors 26 and fax processors 28. The call and fax processors are Pentium III computers with 256 MB of memory and 10 GB of disk storage. The file server 14 stores the voice mail and fax mail files, and the software on the web access server 10 accesses the voice mail and fax mail from the file server 14. The file server 14 stores the account information. The file server 14 is a Pentium III computer with 256 MB of memory and 20 GB of disk storage. The hub 16 is used to connect the call processors 26 and fax processors 28 to the file server, and to connect the web access server 10 to the file server 14. The potential for high Internet usage does not impact the call-processing platform, because the web access server 10 provides all of the required data and processing to a web user 29.

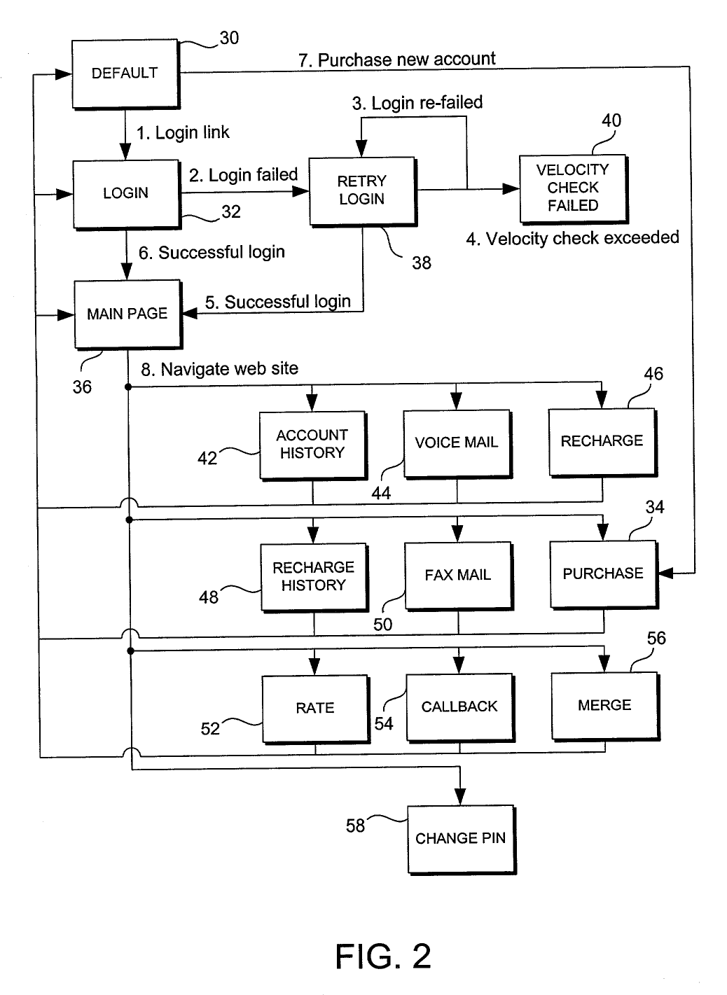

FIG. 2 shows the flow between the web pages. The web user 29 must first navigate to the default web page, which provides company information or welcome information. Upon the start of the process in block 30, the web user must choose to login to the web access software in block 32, or to purchase a new account in block 34. Then the user will enter his/her account number and personal identification number (PIN), and move to the main page in block 36 showing the account number of the user and current account balance. The account number and PIN are validated against the account database in FIG. 1. If the account number or PIN is not valid, then the user is redirected to the retry login page in block 38. The user is allowed to retry the login a configurable number of times (velocity limits). If the user has not exceeded the number of allowed retry attempts, then the user can retry the login in block 38. If the user enters a valid account number and PIN, then they are redirected to the main page in block 36. If the user does not enter a valid account number and PIN and the velocity limits are exceeded, then the user is redirected in block 40 to the velocity check failed page and the IP address is blocked from future use. The user can navigate to any of the web pages from the main page in step 8, such as the account history page (block 42), the voice mail page (block 44), the account recharge page (block 46), the recharge history page (block 48), the fax mail page (block 50), the rate page (block 52), the callback page (block 54), the merge page (block 56), or the change pin page (block 58).

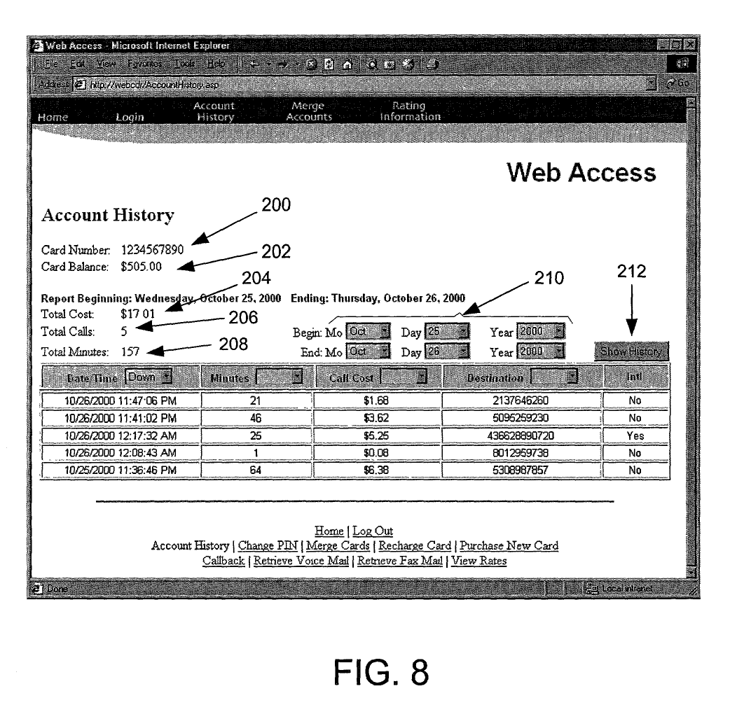

The account history web page, shown in FIG. 8, displays the account number 200 and account balance 202—tracked within file server 14—and the total cost 204, total calls 206, and total minutes 208 for the selected report tracked by web access server 10. The user can select a report date range 210, and click the “Show History” button 212 to view another report range. The user can view and sort the outgoing calls in a table by date, minutes, cost or destination in ascending or descending order with column for listing if the call is an international one.

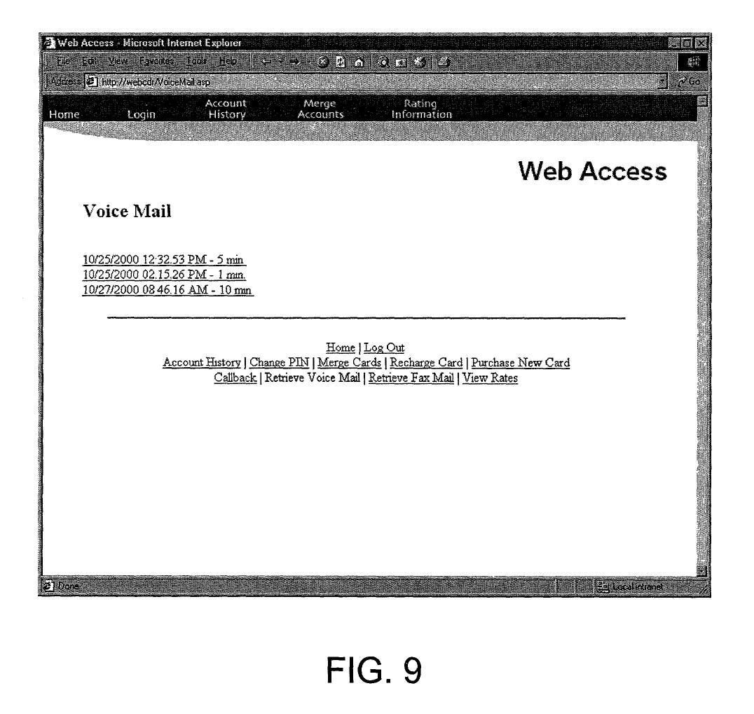

The other pages are similarly arranged to that in FIG. 8. For instance, the voice mail web page, shown in FIG. 9, lists in temporal order the voice mails received for the particular account. The user can click on each of the items listed which is hyperlinked to an object stored on file server 14 to listen or download voice mail messages. The date, time and message length is displayed on the voice mail page. Voice mails are uploaded to the user computer from the file server 14 and through the web access server 10 to the web user 29 in any one of a variety of known formats (e.g. AVI, WAVE, windows media, real audio, or Quicktime) for playback on the web user's computer 29.

Other pages are the recharge web page, which allows the user to enter their credit card information and the amount that they wish to recharge their account for prepaid usage. The fax mail web page is set up similarly to the voice mail web page shown in FIG. 9 in that it allows the user to view or download fax mails, stored in file server 14 and listed on the page in the order received. The date, time and number of pages are displayed on the fax mail page. The purchase account web page allows the user to enter their credit card information and the amount that they wish to purchase for the user's prepaid user account. The rate web page displays the rate information for the account. The callback web page allows the user to initiate a callback to the callback phone number that is stored in the account database on the file server 14. The merge accounts web page allows the user to enter the account number and PIN of the prepaid accounts they wish to merge. Finally, the change PIN web page allows a user to change their PIN by entering the old PIN and the new PIN.

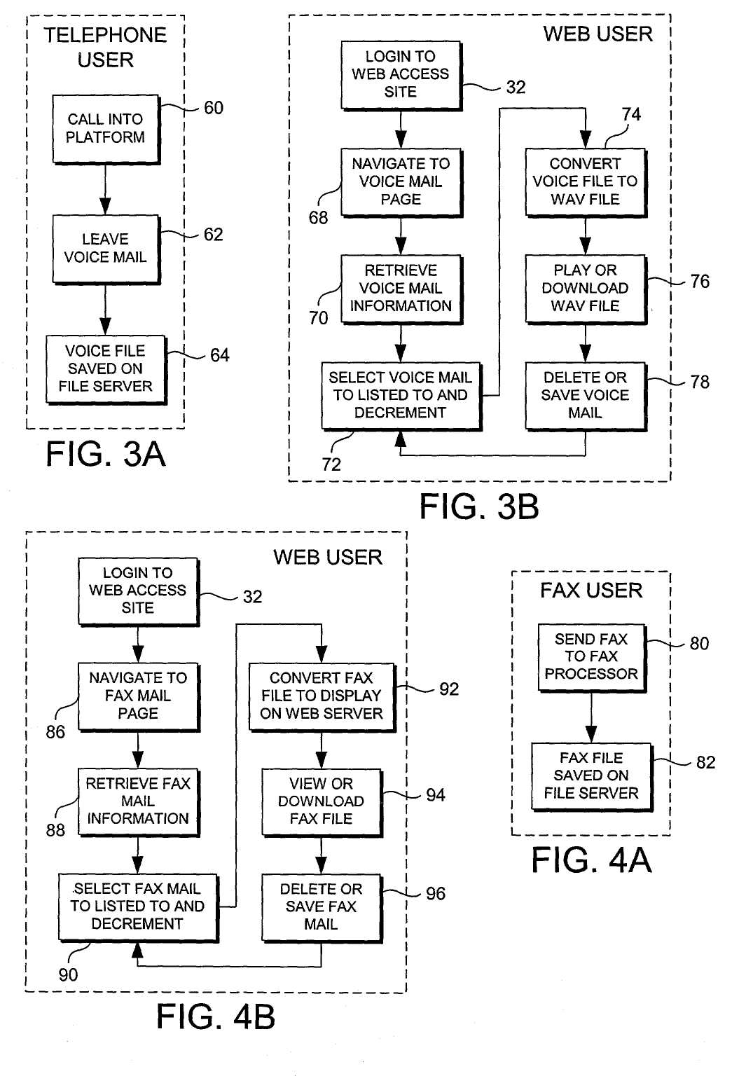

FIGS. 3A and 3B show, respectively, the process flow for the telephone user to leave a voice mail message, and the flow of the web user to retrieve voice mail messages. In FIG. 3A, the telephone user must first dial into the call processor in block 60, and choose to leave a voice mail message in block 62. Then the call processor stores the voice mail message on the file server 14 as a VOX file in block 64. As shown in FIG. 3B, the web users must login to the web site in block 32, and navigate to the voice mail page in block 68 (the page also shown as block 44 in FIG. 2 and in FIG. 9). The web access server 10 will retrieve the voice mail information from the file server in block 70, including the length of the message and the date and time the message was stored. Then the web user will select a specific voice mail message to listen to in block 72, and the web access server will decrement the account by a predetermined fee. The VOX file is converted to a WAV file in block 74, and the web user can download or play the WAV file in block 76. The web user can delete or save a specific voice mail message in block 78.

FIGS. 4A and 4B show, respectively, the process for the fax user to leave a fax mail, and the process flow of the web user to retrieve fax mails. The fax user must send the fax mail to the fax processor in block 80. The fax processor saves the fax on the file server in block 82. As shown in FIG. 4B, the web users must login to the web site in block 32, and navigate to the fax mail page in block 86 (also shown as block 50 in FIG. 2). The web access server will retrieve the fax mail information from the file server in block 88, including the number of pages and the date and time the fax was stored. Then the web user will select a specific fax mail to view in block 90, and the web access server will decrement the account by a predetermined fee. The fax file is converted to a GIF or JPEG image in block 92, and the web user can download or view the fax mail in block 94. The web user can delete or save a specific fax mail in block 96.

FIGS. 5A and SB show, respectively, the process for a telephone user to complete calls and recharge their account on the call processor, and the process flow of the web user to view account history and recharge history. The telephone user must first dial into the call processor in block 98. Then the user can then complete a phone call or recharge their account in blocks 100, 102. The telephone user lastly exits the call processor system in block 104. Referring now to FIG. 5B, the web users may then login to the web site in block 32. The web user can navigate to the account history page (block 42 in FIG. 2) or the recharge history page (block 48 in FIG. 2) in blocks 108 and 110, respectively. The account history details and the recharge history details are displayed in blocks 112 and 114, respectively. The recharge history can be incorporated with the account history to create a single report in the future.

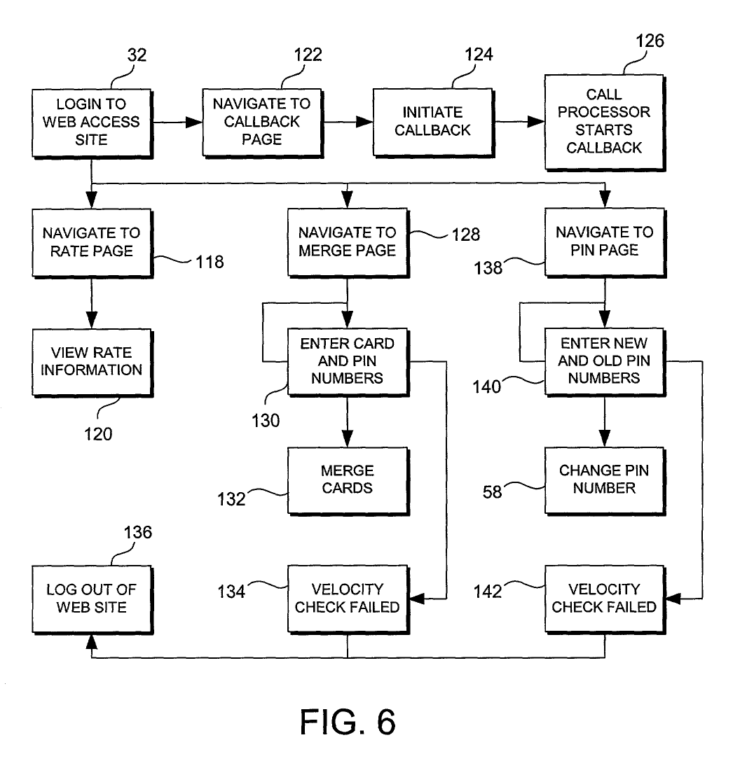

FIG. 6 shows the flow for web user to view rates, initiate a callback, merge accounts, and to change PIN numbers. The web user must login to the web site in block 32. The user can navigate to the rate page in block 118, and the web access server will retrieve the rate information from the file server and display the information in block 120. The user can also navigate to the callback page in block 122. The user can initiate the callback by clicking the initiate button in block 124, and the call processor will start the callback process in block 126. The call processor will call the predefined callback phone number that is stored in the account database on the file server. The user can alternately navigate to the merge page in block 128. The user must enter the account number and PIN for the account to merge in block 130. Then the web access server will merge the two accounts in block 132. If the account number or PIN is invalid in block 130, the user is allowed to retry. If the user exceeds the velocity limits in block 130, then the user is redirected to the velocity check failed page and logged out of the web site in blocks 134, 136 and the IP address is blocked. The web user can alternately navigate to the PIN page in block 138. The user must enter the old PIN and new PIN in block 140. If PIN is invalid in block 140, the user is allowed to retry. If the user exceeds the velocity limits in block 140, then the user is redirected to the velocity check failed page and logged out of the web site in blocks 142, 136 and the IP address is blocked.

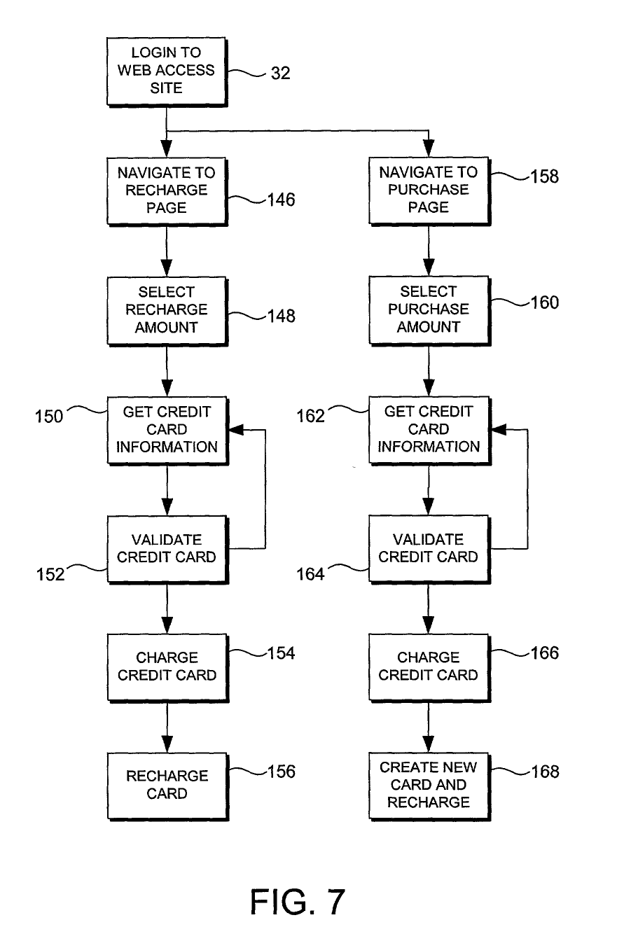

FIG. 7 shows the process flow for the web user to recharge an account or purchase a new account. After logging in to the web access site in block 32, the user can navigate to the recharge page in block 146. Then the user may select an amount to recharge the account in block 148, and the credit account information is retrieved in block 150. The credit account is validated in block 152, and if the credit account is not valid the user must reenter the credit account information in 150. If the credit account information is valid, then the credit account is charged in 154, and the amount is added to the account balance in 156. The user can then navigate to the purchase page in block 158. Then the user must select an amount to purchase the account in block 160, and the credit account information is retrieved in block 162. The credit account is validated in block 164, and if the credit card is not valid the user must reenter the credit card information in block 162. If the credit card information is valid, then the credit card is charged in block 166, and a new account is generated in block 168 with the purchased balance and the account number is given to the user via the web site or an email.

Having described and illustrated the principles of the invention in a preferred embodiment thereof, it should be apparent that the invention can be modified in arrangement and detail without departing from such principles. We claim all modifications and variation coming within the spirit and scope of the following claims.

We claim:

1. A method for storing electronic communications for access over a global communications system, the method comprising:
establishing a prepaid account including a validation number and an account balance;
receiving an electronic communication to said prepaid account;
storing said electronic communication in a central repository;
logging in to said central repository from a remote computer using the validation number;
serving said electronic communication to the remote computer; and
decrementing the prepaid account.

2. The method of claim 1, wherein the electronic communication is a voice mail, the method further including:
receiving a plurality of voice mail communications at the central repository;
presenting a list including said voice mail messages for selection to the remote computer; and
serving said selected voice mail message to the remote computer.

3. The method of claim 1, wherein the electronic communication is a facsimile, the method further including:
receiving a plurality of facsimile communications at the central repository;
presenting a list including said facsimiles for selection to the remote computer; and
serving said selected facsimile to the remote computer.

4. The method of claim 1, further including the step of enabling the account balance to be increased.

5. The method of claim 4, further including the steps of:
tracking each time and amount the account balance is increased;
compiling a historical record of the account balance increases; and
serving said increases to the remote computer.
